(19) United States
(12) Patent Application Publication
(10) Pub. No.: US 2025/0190521 A1
(43) Pub. Date: Jun. 12, 2025

(54) METHOD AND APPARATUS FOR TRANSPOSING MATRIX FOR EFFICIENT PROCESSING OF ARTIFICIAL NEURAL NETWORK

(71) Applicant: ELECTRONICS AND TELECOMMUNICATIONS RESEARCH INSTITUTE, Daejeon (KR)

(72) Inventor: Hyun Mi KIM, Daejeon (KR)

(73) Assignee: ELECTRONICS AND TELECOMMUNICATIONS RESEARCH INSTITUTE, Daejeon (KR)

(21) Appl. No.: 18/963,155

(22) Filed: Nov. 27, 2024

(30) Foreign Application Priority Data
Dec. 8, 2023 (KR) 10-2023-0177677
Oct. 14, 2024 (KR) 10-2024-0139519

(51) Int. Cl. G06F 17/16

(52) U.S. Cl. CPC G06F 17/16

(57) ABSTRACT

An apparatus and a method for transposing matrix are disclosed. The apparatus includes a data interface that receives a plurality of matrix data included in an M×N matrix, a control unit that acquires a plurality of write address values and a plurality of read address values in accordance with a size of the plurality of matrix data and a size of the matrix data, a data receiving unit that stores the plurality of matrix data in accordance with the plurality of write address values in a memory module including a plurality of memory banks, and a transposed matrix generating unit that acquires a plurality of storage data from the memory module in accordance with the plurality of read address values, acquires the plurality of storage data as transposed matrix data, and stores the transposed matrix data in a matrix operator.

### CROSS-REFERENCE TO RELATED APPLICATION

This application claims priority from Korean Patent Application No. 10-2023-0177677, filed on Dec. 8, 2023, and Korean Patent Application No. 10-2024-0139519, filed on Oct. 14, 2024, which are hereby incorporated by reference for all purposes as if fully set forth herein.

### TECHNICAL FIELD

The present disclosure relates to a method and an apparatus for transposing a matrix for efficient processing of an artificial neural network.

### BACKGROUND

Contents described below merely provide background information relating to the present embodiment, and do not constitute the related art.

A matrix operation is a core operation of an artificial neural network operation in an artificial neural network structure.

Data and a weight value for the artificial neural network operation are handled in a form of a matrix, and are stored in the form of the matrix in a memory area of an artificial neural network processing apparatus. In general, matrix data stored in a memory by a load command in the artificial neural network processing apparatus in the artificial neural network structure is transferred to matrix operation dedicated hardware (for example, a matrix multiply and accumulate (MAC) accelerator), and after a fast operation is performed in operation dedicated hardware, a result value is stored back in the form of the matrix in the memory.

In various artificial neural network structures, a matrix transposition operation is one of frequently used essential operations.

In the artificial neural network structure, a weight value matrix or an intermediate data matrix which are stored in a forward path during a learning operation is transposed and used in a matrix multiplication operation in a backward path. Therefore, a dedicated acceleration hardware configuration for the matrix transposition operation has a significant impact on performance of the artificial neural network structure.

The matrix transposition operation represents an operation for exchanging a row and a column, based on a diagonal of the matrix. That is, the matrix transposition operation represents an operation for changing an M×N matrix to an N×M matrix. In order to implement this operation, a matrix transposition dedicated buffer for storing the M×N matrix read from the memory and an additional execution logic (for example, a rotator, a shifter, or the like) for exchanging the row and the column are required.

When sizes of M and N are small, the matrix transposition operation may be implemented as a small buffer and a small amount of execution logics. However, in order to process a Large Language Model (LLM) which recently becomes important, a large buffer and many logics are additionally required for a fast transposition operation of a large matrix, and accordingly, an execution time required for the transposition operation of the large matrix increases.

FIG. 1 is a diagram illustrating a conceptual diagram of a general artificial neural network processing apparatus including a matrix transposition operator.

In an artificial neural network processing apparatus (10), artificial neural network data and weight value data which are stored in a large-capacity off-chip memory (11) are transferred to an artificial neural network processing dedicated chip (AI Processor Chip, 100) by using a high-bandwidth memory interface (12).

The artificial neural network processing dedicated chip (100) includes one or more AI processing cores (110), and the one or more AI processing cores (110) are each connected to an off-chip memory (11) by a dedicated Network on Chip (NoC, 120).

The dedicated NoC (120) is implemented as a network for data movement between the off-chip memory (11) and the AI processing core (110), or for data movement between mutually different AI processing cores (110).

Each of the AI processing cores (110) includes a fast on-chip memory (111) and a high-performance dedicated matrix operator (112) for artificial neural network processing. Here, the on-chip memory (111) may be implemented as a static random access memory (SRAM).

The matrix operator (112) may be implemented as an array of operators (processing elements; PEs) such as a systolic array, mainly for matrix operation acceleration processing.

In addition, a core internal matrix operator dedicated network (113) is responsible for fast data transmission between the on-chip memory (111) and the matrix operator (112).

Data stored in the on-chip memory (111) is allocated to be reusable as much as possible.

In general, for the matrix transposition operation, matrix data is loaded to and stored in a transposition operator (114) from the on-chip memory (111) by using a data transmission network (115).

The matrix data is loaded and stored in a transposition operation dedicated buffer (1141) in the transposition operator (114). Here, the transposition operation dedicated buffer (1141) may be implemented as the SRAM or a register.

A transposition operation logic (1142) performs the transposition operation by using the data stored in a transposition operation dedicated buffer (1141). When a transposition operation result is stored back in the buffer (1141), the transposition operation logic (1142) is implemented in a form in which the buffer (1141) stores the transposition operation result in the on-chip memory (111) by using the data transmission network (115).

The AI processing core (110) configured in this form causes an increase in hardware resources and an increase in a transposition operation processing time. Therefore, operation performance of the artificial neural network structure is degraded as a whole.

### SUMMARY

The present disclosure mainly aims to provide a method and an apparatus for transposing a matrix for efficient processing of an artificial neural network.

The problems to be solved by the present disclosure are not limited to the problems described above, and other problems not described herein will be clearly understood by those skilled in the art from the description below.

According to an aspect of the present disclosure, a matrix transposition apparatus is provided, the matrix transposition apparatus including a data interface that receives a plurality of matrix data included in an M×N matrix (where M and N are each integer of two or more); a control unit that acquires a plurality of write address values and a plurality of read address values in accordance with a size of the plurality of matrix data and a size of the matrix data; a data receiving unit that stores the plurality of matrix data in accordance with the plurality of write address values in a memory module including a plurality of memory banks; and a transposed matrix generating unit that acquires a plurality of storage data from the memory module in accordance with the plurality of read address values, acquires the plurality of storage data as transposed matrix data, and stores the transposed matrix data in a matrix operator.

According to another aspect of the present disclosure, a matrix transposition method is provided, the matrix transposition method including a data interface process for receiving a plurality of matrix data included in an M×N (where M and N are each integer of two or more) matrix; a control process for acquiring a plurality of write address values and a plurality of read address values in accordance with a size of the plurality of matrix data and a size of the matrix data; a data receiving process for storing the plurality of matrix data in accordance with the plurality of write address values in a memory module including a plurality of memory banks; and a transposed matrix generation process for acquiring a plurality of storage data from the memory module in accordance with the plurality of read address values, acquiring the plurality of storage data as transposed matrix data, and storing the transposed matrix data in a matrix operator.

As described above, according to the embodiment of the present disclosure, there are advantageous effects as follows. The matrix transposition operation is performed, based on the on-chip memory module having a matrix transposition operation function and a dedicated address generator. Therefore, it is possible to implement an artificial neural network processing apparatus which can efficiently perform the matrix transposition operation without requiring additional large hardware resources such as a dedicated buffer for the matrix transposition operation or additional execution time for the matrix transposition operation.

The advantageous effects of the present disclosure are not limited to the advantageous effects described above, and other advantageous effects not described herein will be clearly understood by those skilled in the art from the description below.

### BRIEF DESCRIPTION OF THE DRAWINGS

FIG. 1 is a schematic diagram illustrating a general artificial neural network processing apparatus including a matrix transposition operator.

FIG. 2 is a block diagram illustrating a configuration of a conceptual diagram of the artificial neural network processing apparatus including a matrix transposition apparatus according to one embodiment of the present disclosure.

FIG. 3 is a block diagram illustrating a configuration of the matrix transposition apparatus according to the embodiment of the present disclosure.

FIG. 4 is a block diagram illustrating a configuration of the matrix transposition apparatus according to the embodiment of the present disclosure.

FIG. 5 is a diagram illustrating an example of input matrix data stored in a large-capacity off-chip memory (11) and an M×N sub-matrix loaded for an operation.

FIG. 6 is a diagram illustrating a pseudo-code executed by a control unit (320) to acquire a plurality of write address values.

FIG. 7 is a diagram illustrating locations of a plurality of matrix data stored in a plurality of memory banks in accordance with the plurality of acquired write address values.

FIG. 8 is a diagram illustrating a pseudo-code executed by the control unit (320) to acquire a plurality of read address values.

FIG. 9 is a diagram illustrating transposed matrix data stored in a matrix operator (430).

FIG. 10 is a diagram illustrating a non-square M×N input matrix.

FIG. 11 is a diagram illustrating a form in which the M×N input matrix in FIG. 10 is stored in a memory module.

FIG. 12 is a diagram illustrating a form in which memory module data in FIG. 11 is transposed and stored in the matrix operator.

FIG. 13 is a flowchart illustrating a matrix transposition method according to the present embodiment.

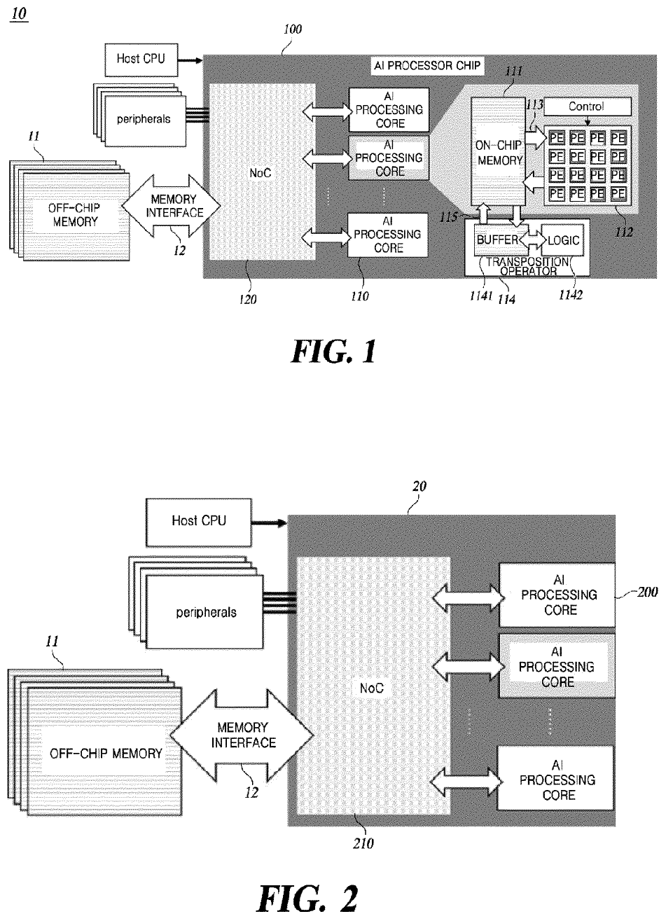

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure and is not intended to represent the only embodiments in which the present disclosure may be practiced.

FIG. 2 is a block diagram illustrating a configuration of a conceptual diagram of an artificial neural network processing apparatus including a matrix transposition apparatus according to one embodiment of the present disclosure.

As illustrated in FIG. 2, an artificial neural network processing apparatus (20) includes at least one AI processing core (200) and NoC (210).

Each AI processing core (200) is connected to each off-chip memory (11) by using the NoC (210).

The NoC (210) is implemented as a network for data movement between the off-chip memory (11) and the AI processing core (200) or for data movement between the AI processing cores (110).

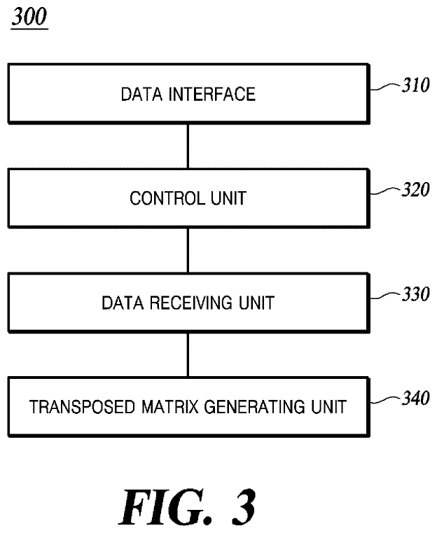

FIG. 3 is a block diagram illustrating a configuration of the matrix transposition apparatus according to the embodiment of the present disclosure.

A matrix transposition apparatus (300) according to the embodiment of the present disclosure implements the AI processing core (200).

As illustrated in FIG. 3, the matrix transposition apparatus (300) according to the embodiment of the present disclosure includes a data interface (310), a control unit (320), a data receiving unit (330), and a transposed matrix generating unit (340). The matrix transposition apparatus (300) according to the present embodiment may be implemented by omitting some components from components in FIG. 3, or may be implemented by adding other components not illustrated in FIG. 3.

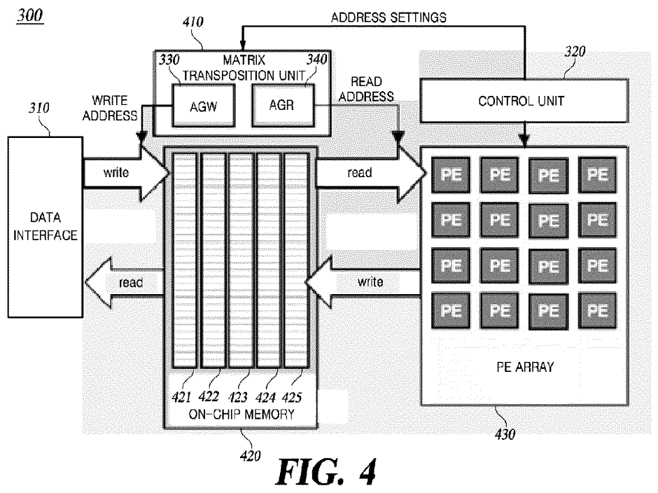

FIG. 4 is a block diagram illustrating a configuration of the matrix transposition apparatus according to the embodiment of the present disclosure.

As illustrated in FIG. 4, the matrix transposition apparatus (300) may include a matrix transposition unit (410), a memory module (420), and a matrix operator (430).

A function of the matrix transposition unit (410) may be implemented to include a function of the data receiving unit (330) and a function of the transposed matrix generating unit (340).

Hereinafter, the matrix transposition apparatus (300) will be described with reference to FIGS. 2 to 4.

The data interface (310) receives a plurality of matrix data included in an M×N (where M and N are each integers of two or more) matrix from the off-chip memory (11).

For reference, in a matrix, a row and a column may each mean a first dimension and a second dimension. The first dimension may mean the column, and the second dimension may mean the row.

In the following description, it is assumed that the first dimension in the matrix represents the row and the second dimension represents the column.

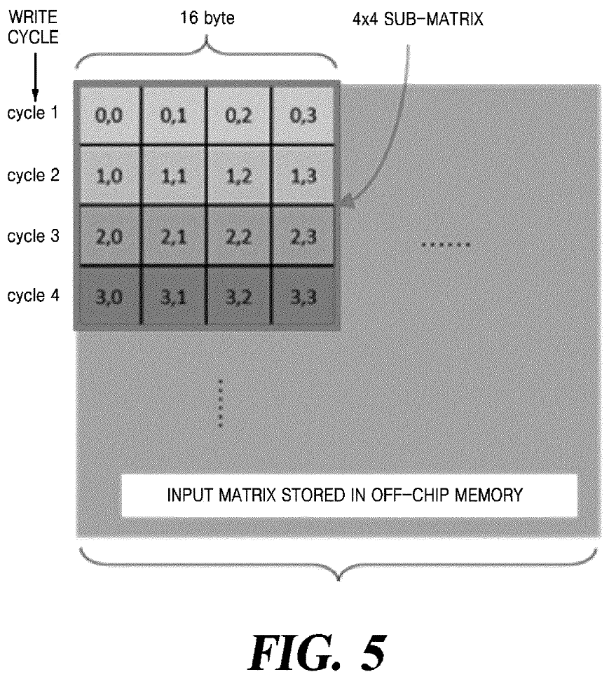

FIG. 5 is a diagram illustrating an example of input matrix data stored in the large-capacity off-chip memory (11) and an M×N sub-matrix loaded for an operation.

The M×N matrix may be an input matrix stored in the off-chip memory (11), or may be a sub-matrix of an input matrix. In the following description, it is assumed that the M×N matrix is a square 4×4 sub-matrix.

The data interface (310) reads the plurality of matrix data in a 4×4 matrix as illustrated in FIG. 5 from the off-chip memory (11) by using the NoC (120) by a maximum bitwidth (hereinafter, referred to as a first bitwidth) of the NoC (120). Therefore, a size of the plurality of matrix data which can be read at one time by the data interface (310) will be defined as a first bitwidth NW (NoC bitwidth).

The plurality of matrix data read one at a time by the data interface (310) for a write operation of one write cycle (cycle 1, cycle 2, cycle 3, or cycle 4) in the M×N matrix as illustrated in FIG. 5 is data consecutive in a second dimension (that is, the column) direction. The number of matrix data that can be read at one time is calculated by dividing the first bitwidth of data that can be read from the NoC (120) by a size of one matrix data. In the following description, unless otherwise specified, it is assumed that the first bitwidth NW is 16 bytes and a size DW (data bitwidth) of one matrix data is 4 bytes.

As illustrated in FIG. 5, when a 16-byte size corresponding to four matrix data is the first bitwidth, the data interface (310) reads every four 4-byte matrix data (that is, partial matrix data having a 1×4 size) for an operation of each read cycle. In this manner, four partial matrix data having the 1×4 size for an operation of four read cycles (cycle 1 to cycle 4) can be sequentially read to read all 4×4 matrix data.

The plurality of matrix data read by the data interface (310) are stored in a memory bank in the memory module (420) for each read cycle by the data receiving unit (330).

The memory module (420) is an on-chip memory including a plurality of memory banks (421, 422, 423, 424, and 425), and the number of the memory banks included in the plurality of memory banks (421, 422, 423, 424, and 425) is determined depending on an offset value which is a value obtained by dividing the size NW of the plurality of matrix data by the size DW of one matrix data, as in Equation 1. For example, the number BN of the memory banks (421, 422, 423, 424, and 425) can be determined as [offset value+1].

$$BN = \frac{NW}{DW} + 1 \qquad [ Equation 1 ]$$

The number BN of the memory banks (421, 422, 423, 424, and 425) is not limited to the number calculated by Equation 1, and may be a value greater than [offset value+1] depending on the embodiment.

The control unit (320) fulfills a dedicated address generator function by acquiring the plurality of write address values and the plurality of read address values in accordance with the size of the plurality of matrix data and the size of one matrix data.

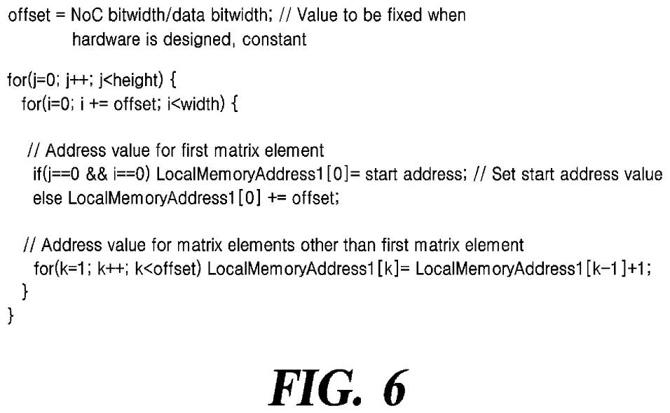

FIG. 6 is a diagram illustrating a pseudo-code executed by the control unit (320) to acquire the plurality of write address values.

In FIG. 6, a height and a width each represent the length of the first dimension and the length of the second dimension of the M×N matrix. For reference, in the present embodiment, the meaning of the length represents the number of matrix data.

In the pseudo-code in FIG. 6, an offset value is acquired. The offset value is a value calculated by using NC which is the NoC bitwidth and DW which is the data bitwidth, that is, as NW/DW.

The control unit (320) acquires the plurality of write address values LocalMemoryAddress1 [ ] so that each of the matrix data included in a first plurality of matrix data (that is, matrix data in a yellow region) (0,0), (0,1), (0,2), and (0,3) belonging to the 4×4 matrix in FIG. 5 is stored in mutually different memory banks, for the operation of the first write cycle (that is, the cycle 1).

For this purpose, the control unit (320) allocates a start address (for example, 0) which is an address value set in advance in a write start address value LocalMemoryAddress1 [0] for storing first matrix data (that is, when i=0 and j=0), and increases the values of LocalMemoryAddress1 [1], . . . , LocalMemoryAddress1 [offset-1] by 1. That is, LocalMemoryAddress1 [1]=LocalMemoryAddress1 [0]+1, LocalMemoryAddress1 [2]=LocalMemoryAddress1 [1]+1, LocalMemoryAddress1 [3]=LocalMemoryAddress1 [2]+1 are established. In this way, the control unit (320) generates the plurality of write address values LocalMemoryAddress1 [ ] corresponding to the offset value.

That is, the number of the plurality of write address values is the same as the offset value which is a value obtained by dividing the size of the first plurality of matrix data by the size of one matrix data, and the plurality of write address values have address values consecutive from the write start address value.

The control unit (320) increases the write start address value of the first plurality of previously stored matrix data by the offset value, and thereafter, repeatedly acquires another second plurality of write address values.

The control unit (320) acquires the plurality of write address values LocalMemoryAddress1 so that each of the matrix data included in the second plurality of matrix data (that is, matrix data in a green region) (1,0), (1,1), (1,2), and (1,3) is stored in mutually different memory banks, for the operation of the subsequent write cycle (that is, the cycle 2). For this purpose, the control unit (320) increases and allocates the address value LocalMemoryAddress1 [0] for storing the first matrix data of the second plurality of matrix data by the offset value, sequentially increases the values of LocalMemoryAddress1 [1], . . . , LocalMemoryAddress1 [offset-1] by 1 from LocalMemoryAddress1 [0], and generates the plurality of write address values LocalMemoryAddress1 [ ] corresponding to the offset value. That is, LocalMemoryAddress1 [0] offset, LocalMemoryAddress1 [1] LocalMemoryAddress1 [0]+1, LocalMemoryAddress1 [2]=LocalMemoryAddress1 [1]+1, LocalMemoryAddress1 [3]=LocalMemoryAddress1 [2]+1 are established.

The number of times at which the control unit (320) repeatedly acquires the plurality of write address values is repeated as many times as the value obtained by dividing the size of the M×N matrix by the offset value. That is, the number of times at which the control unit (320) repeatedly acquires the plurality of write address values corresponds to the number of cycles in which the data interface (310) reads the plurality of matrix data.

In this manner, the control unit (320) sequentially generates write address values for a third plurality of matrix data (2,0), (2,1), (2,2), and (2,3) (that is, matrix data in a blue region) and a fourth plurality of matrix data (3,0), (3,1), (3,2), and (3,3) (that is, matrix data in a purple region).

The control unit (320) provides a write address value AGW acquired for the operation of each write cycle to the data receiving unit (330).

The data receiving unit (330) simultaneously stores each of the plurality of matrix data in mutually different memory banks in accordance with the plurality of write address values AGW in the memory module (420) including the plurality of memory banks.

The data receiving unit (330) acquires a memory bank number A1 in accordance with Equation 2, and acquires an address value B1 in the memory bank in accordance with Equation 3.

$$A 1 = LocalMemoryAddress 1 \% BN \qquad [ Equation 2 ]$$

$$B 1 = LocalMemoryAddress 1 / BN \qquad [ Equation 3 ]$$

The data receiving unit (330) stores each of the matrix data included in the plurality of matrix data in mutually different memory banks in accordance with the plurality of write address values AGW.

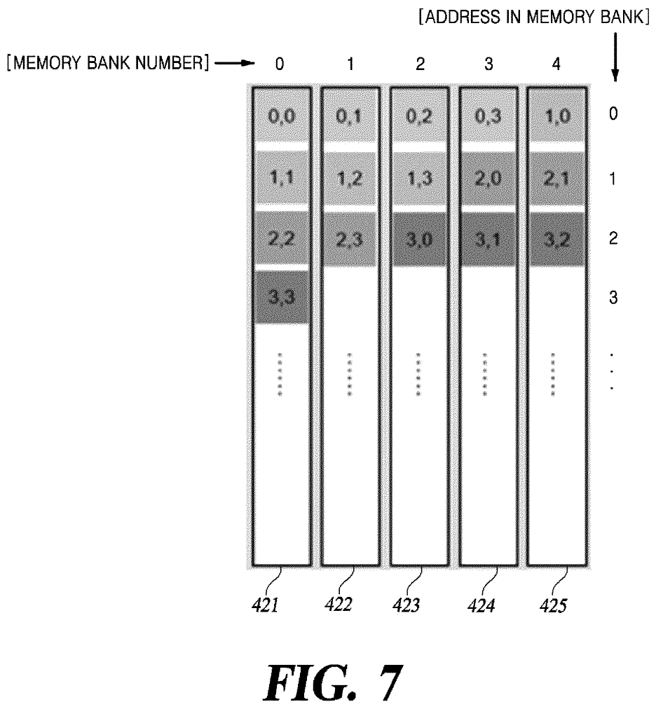

FIG. 7 is a diagram illustrating locations of the plurality of matrix data stored in the plurality of memory banks in accordance with the plurality of acquired write address values.

As illustrated in FIG. 7, the data receiving unit (330) stores each of the matrix data of (0,0), (0,1), (0,2), and (0,3) in mutually different memory banks (421, 422, 423, and 424) (that is, a portion corresponding to a first region (yellow)) in the first write cycle, stores each of the matrix data of (1,0), (1,1), (1,2), and (1,3) in mutually different memory banks (425, 421, 422, and 423) (that is, a portion corresponding to a second region (green)) in the second write cycle, stores each of the matrix data of (2,0), (2,1), (2,2), and (2,3) in mutually different memory banks (424, 425, 421, and 422) (that is, a portion corresponding to a third region (blue)) in the third write cycle, and stores each of the matrix data of (3,0), (3,1), (3,2), and (3,3) in mutually different memory banks (423, 424, 425, and 421) (that is, a portion corresponding to a fourth region (purple)) in the fourth write cycle.

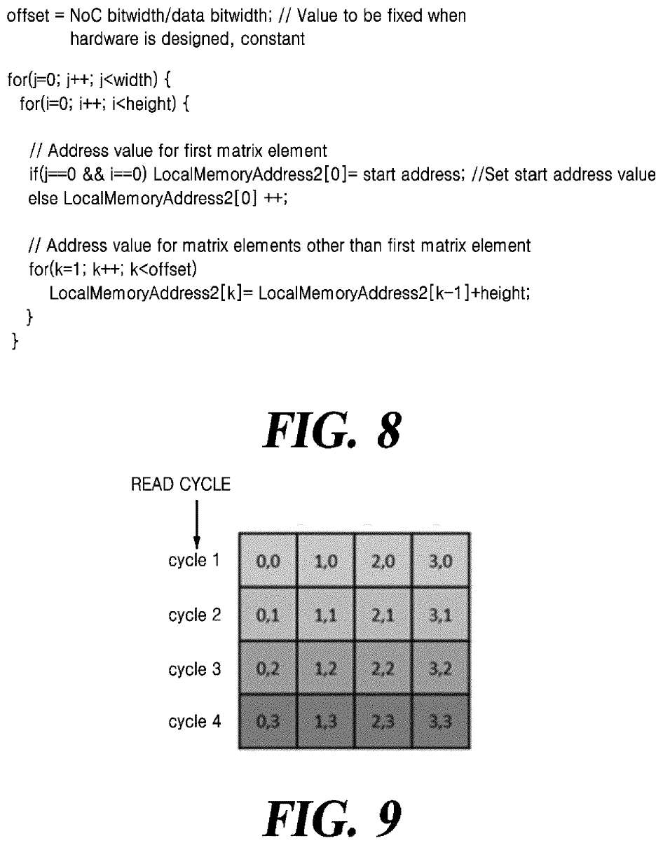

FIG. 8 is a diagram illustrating a pseudo-code executed by the control unit (320) to acquire the plurality of read address values.

In the pseudo-code in FIG. 8, the offset value is acquired. The offset value is a value calculated by using NoC bitwidth/data bitwidth, that is, as NW/DW.

The control unit (320) acquires read address values corresponding to the number of values obtained by dividing the size of the plurality of matrix data by the size of one matrix data (that is, the number corresponding to the offset value) for the read operation of each read cycle. The control unit (320) acquires the plurality of read address values at an interval corresponding to the length of the second dimension (that is, the column) of the M×N matrix, starting from the read start address value. Here, the plurality of read address values are allocated to mutually different memory banks.

The control unit (320) acquires the read address values from the start address of the memory banks (421, 422, 423, 424, and 425) in FIG. 7 for the operation of the first read cycle. Here, it is assumed that the start address is 0.

The control unit (320) repeatedly acquires the read address values at an interval corresponding to the length of the second dimension of the M×N matrix, starting from the start address which is a first read address value (that is, a read start address value LocalMemoryAddress2 [0]), and repeatedly acquires the read address values corresponding to the number of the offset values. Here, the read address values corresponding to the number of the offset values are defined as a first plurality of read address values. The first plurality of read address values LocalMemoryAddress2 [ ] are 0, 4, 8, and 12, and each of the values becomes an address value corresponding to the matrix data (0,0), (1,0), (2,0), and (3,0) of the M×N matrix in FIG. 7.

The control unit (320) additionally acquires the plurality of read address values by increasing the read start address value by 1 from the previous read address value, and the number of times at which the read start address value is increased by 1 is equal to the number of times corresponding to the offset value.

The control unit (320) increases the read start address value LocalMemoryAddress2 [0] by 1 for the read operation of the second read cycle, thereafter, repeatedly acquires the read address values at an interval corresponding to the length of the second dimension of the M×N matrix, and acquires the read address values as many as the number corresponding to the offset value. Here, the number of the read address values corresponding to the offset value is defined as a second plurality of read address values. The second plurality of read address values LocalMemoryAddress2 [ ] are 1, 5, 9, and 13, and each of the values becomes an address value corresponding to the matrix data (0,1), (1,1), (2,1), and (3,1) of the M×N matrix in FIG. 7.

In this manner, the control unit (320) acquires 2, 6, 10, and 14 as a third plurality of read address values LocalMemoryAddress2 [ ] for the read operation of the third read cycle, and acquires 3, 7, 11, and 15 as a fourth plurality of read address values LocalMemoryAddress2 [ ] for the read operation of the fourth read cycle.

The control unit (320) provides a read address value AGR acquired for the operation of each read cycle to the transposed matrix generating unit (340).

The transposed matrix generating unit (340) simultaneously acquires the plurality of storage data from mutually different memory banks of the memory module (420) in accordance with the plurality of read address values AGR.

The transposed matrix generating unit (340) acquires a memory bank number A2 in accordance with Equation 4, and acquires an address value B2 in the memory bank in accordance with Equation 5.

$$A 2 = LocalMemoryAddress 2 \% BN \qquad [ Equation 4 ]$$

$$B 2 = LocalMemoryAddress 2 / BN \qquad [ Equation 5 ]$$

The transposed matrix generating unit (340) acquires the plurality of storage data of the corresponding read cycle from the memory module (420) by using the read addresses acquired for the read operation of each read cycle.

The transposed matrix generating unit (340) concatenates the plurality of storage data to be acquired as the transposed matrix data, and stores the transposed matrix data by transmitting the transposed matrix data to the matrix operator (430).

For reference, the read operation of each read cycle may be performed separately from the write operation after the write operations of all write cycles are completed, but the read operation of the corresponding read cycle may be performed after the operation of each write cycle is completed.

FIG. 9 is a diagram illustrating the transposed matrix data stored in the matrix operator (430).

As illustrated in FIG. 9, the transposed matrix generating unit (340) stores the transposed matrix data as data consecutive in the second dimension in the transposed matrix.

That is, the transposed matrix generating unit (340) stores the transposed matrix data (0,0), (1,0), (2,0), and (3,0) corresponding to the plurality of read address values in the first read cycle as data consecutive in the second dimension in the transposed matrix in FIG. 9.

In addition, the transposed matrix generating unit (340) stores each of the transposed matrix data (0,1), (1,1), (2,1), and (3,1) corresponding to the second plurality of read address values in the second read cycle, stores each of the transposed matrix data (0,2), (1,2), (2,2), and (3,2) corresponding to the third plurality of read address values in the third read cycle, and stores each of the transposed matrix data (0,3), (1,3), (2,3), and (3,3) corresponding to the fourth plurality of read address values in the fourth read cycle, as the data consecutive in the second dimension in the transposed matrix in FIG. 9.

Meanwhile, the matrix operator (430) may be implemented as an array of operators (PEs) such as a systolic array for matrix operation acceleration processing, and is responsible for fast data transmission through a matrix operator dedicated network between the memory module (420) and the matrix operator (430).

In this way, the matrix transposition apparatus (300) may transpose the matrix and store the matrix in the matrix operator (430) without performing an operation for changing a matrix array by using an additional memory or a buffer (1141) as in the method in the related art.

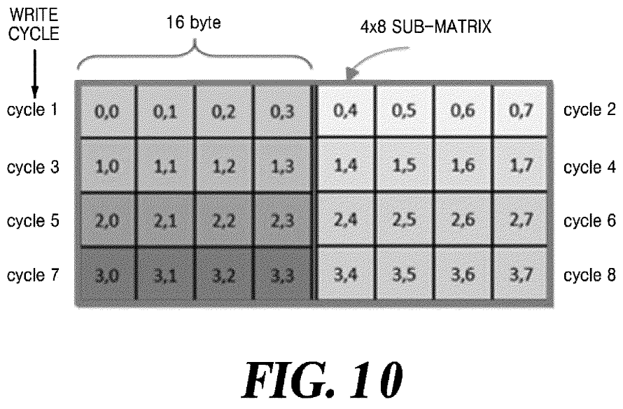

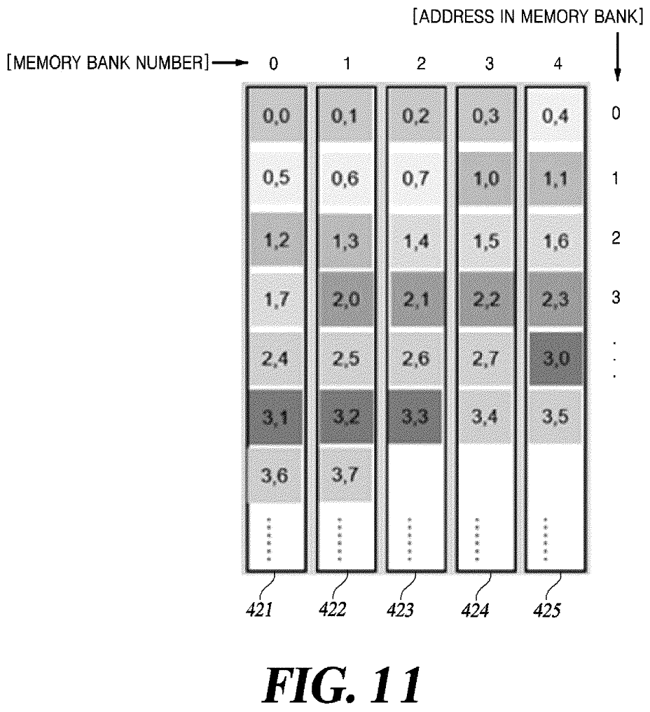

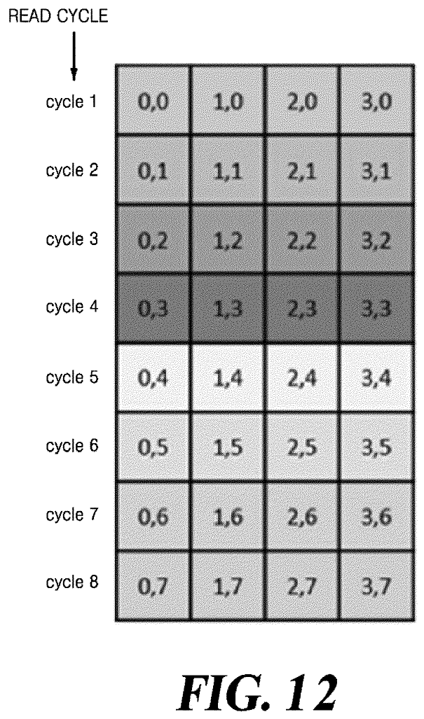

FIG. 10 is a diagram illustrating a non-square M×N input matrix, FIG. 11 is a diagram illustrating a form in which the M×N input matrix in FIG. 10 is stored in the memory module, and FIG. 12 is a diagram illustrating a form in which a memory module data in FIG. 11 is transposed and stored in the matrix operator.

In a case of the non-square M×N matrix (where M and N are mutually different integers of two or more) as in FIG. 10, the control unit (320) generates the write address for the M×N matrix in FIG. 10 for the write operation of each write cycle (cycle 1 to cycle 8). The data receiving unit (330) performs the write operation in each of the write cycles (cycle 1 to cycle 8) in accordance with the write address generated for each write cycle, and stores the M×N matrix as in FIG. 11.

In addition, when the control unit (320) generates the read address for each read cycle for the M×N matrix in FIG. 10, the transposed matrix generating unit (340) may perform the read operation for each read cycle (cycle 1 to cycle 8) in accordance with the generated read address, and may store data on the memory module (420) in FIG. 11 in the matrix operator (430) in a form in which the matrix is transposed as illustrated in FIG. 12.

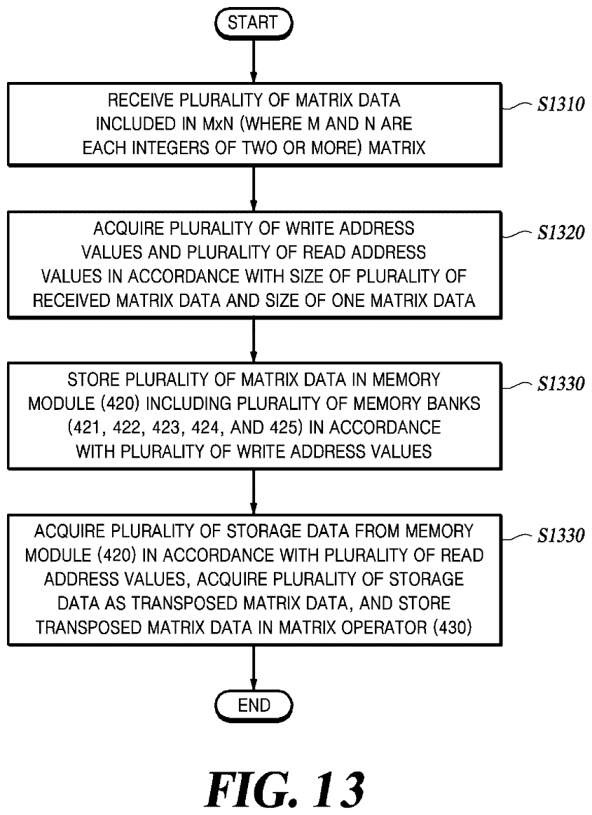

FIG. 13 is a flowchart illustrating a matrix transposition method according to the present embodiment.

The matrix transposition method according to the present embodiment is a method performed by the matrix transposition apparatus (300).

Hereinafter, the matrix transposition method according to the present embodiment will be described with reference to FIGS. 2 to 13.

The data interface (310) performs a data interface process for receiving the plurality of matrix data included in the M×N matrix (where M and N are each integers of two or more) (S1310).

The control unit (320) performs a control process for acquiring the plurality of write address values and the plurality of read address values in accordance with the size of the plurality of received matrix data and the size of one matrix data (S1320).

The data receiving unit (330) performs a data receiving process for storing the plurality of matrix data in the memory module (420) including the plurality of memory banks (421, 422, 423, 424, and 425) in accordance with the plurality of write address values (S1330).

The transposed matrix generating unit (340) acquires the plurality of storage data from the memory module (420) in accordance with the plurality of read address values, acquires the plurality of storage data as the transposed matrix data, and performs a transposed matrix generating process for storing the transposed matrix data in the matrix operator (430) (S1340).

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A matrix transposition apparatus comprising:
a data interface that receives a plurality of matrix data included in an M×N matrix (where M and N are each integer of two or more);
a control unit that acquires a plurality of write address values and a plurality of read address values in accordance with a size of the plurality of matrix data and a size of the matrix data;
a data receiving unit that stores the plurality of matrix data in accordance with the plurality of write address values in a memory module including a plurality of memory banks; and
a transposed matrix generating unit that acquires a plurality of storage data from the memory module in accordance with the plurality of read address values, acquires the plurality of storage data as transposed matrix data, and stores the transposed matrix data in a matrix operator.

2. The matrix transposition apparatus of claim 1,
wherein the number of memory banks in the plurality of memory banks is determined depending on an offset value which is a value obtained by dividing the size of the plurality of matrix data by the size of the matrix data.

3. The matrix transposition apparatus of claim 2,
wherein the number of the memory banks is [offset value+1].

4. The matrix transposition apparatus of claim 1,
wherein the control unit acquires the plurality of write address values so that each matrix data included in the plurality of matrix data is stored in the memory banks which are different from each other.

5. The matrix transposition apparatus of claim 4,
wherein the number of the plurality of write address values is the same as the offset value which is a value obtained by dividing the size of the plurality of matrix data by the size of the matrix data, and the plurality of write address values are address values consecutive from a write start address value.

6. The matrix transposition apparatus of claim 5,
wherein the control unit repeatedly acquires the plurality of write address values different from the write start address value by increasing the write start address value by the offset value.

7. The matrix transposition apparatus of claim 6,
wherein the number of repetitions is determined depending on a value obtained by dividing a size of the M×N matrix by the offset value.

8. The matrix transposition apparatus of claim 1,
wherein the plurality of matrix data are data consecutive in a second dimension direction of the M×N matrix.

9. The matrix transposition apparatus of claim 1,
wherein the control unit acquires the read address values so that the number of the acquired read address values corresponds to a number obtained by dividing the size of the plurality of matrix data by the size of the matrix data, and repeatedly acquires the plurality of read address values at an interval corresponding to a first dimension length of the M×N matrix, starting from a read start address value.

10. The matrix transposition apparatus of claim 9,
wherein the number of repetitions is a number corresponding to the offset value.

11. The matrix transposition apparatus of claim 9,
wherein the control unit acquires the plurality of read address values by increasing the read start address value by 1, and the number of times at which the read start address value is increased by 1 is the same as the number of times corresponding to the offset value.

12. The matrix transposition apparatus of claim 9,
wherein the transposed matrix generating unit stores the transposed matrix data as data in a second dimension direction in the transposed matrix.

13. A matrix transposition method comprising:
a data interface process for receiving a plurality of matrix data included in an M×N (where M and N are each integer of two or more) matrix;
a control process for acquiring a plurality of write address values and a plurality of read address values in accordance with a size of the plurality of matrix data and a size of the matrix data;
a data receiving process for storing the plurality of matrix data in accordance with the plurality of write address values in a memory module including a plurality of memory banks; and
a transposed matrix generation process for acquiring a plurality of storage data from the memory module in accordance with the plurality of read address values, acquiring the plurality of storage data as transposed matrix data, and storing the transposed matrix data in a matrix operator.

14. The matrix transposition method of claim 13,
wherein the number of memory banks in the plurality of memory banks is determined depending on an offset value which is a value obtained by dividing the size of the plurality of matrix data by the size of the matrix data.

15. The matrix transposition method of claim 13,
wherein in the control process, the plurality of write address values are acquired so that each matrix data included in the plurality of matrix data is stored in the memory banks which are different from each other.

16. The matrix transposition method of claim 15,
wherein the number of the plurality of write address values is the same as the offset value which is a value obtained by dividing the size of the plurality of matrix data by the size of the matrix data, and the plurality of write address values are address values consecutive from a write start address value.

17. The matrix transposition method of claim 13,
wherein the plurality of matrix data are data consecutive in a second dimension direction of the M×N matrix.

18. The matrix transposition method of claim 13,
wherein in the control process, the read address values are acquired so that the number of the acquired read address values corresponds to a number obtained by dividing the size of the plurality of matrix data by the size of the matrix data, and the plurality of read address values are repeatedly acquired at an interval corresponding to a first dimension length of the M×N matrix, starting from a read start address value.

19. The matrix transposition method of claim 18,
wherein the number of repetitions is a number corresponding to the offset value.

20. The matrix transposition method of claim 18,
wherein in the control process, the plurality of read address values are acquired by increasing the read start address value by 1, and the number of times at which the read start address value is increased by 1 is the same as the number of times corresponding to the offset value.
